(19) United States
(12) Patent Application Publication
(10) Pub. No.: US 2023/0024970 A1
(43) Pub. Date: Jan. 26, 2023

(54) UNIVERSAL WARRANTY EXCHANGE PROTOCOL FOR UNSUPPORTED TECHNOLOGIES

(71) Applicant: Dell Products, L.P., Round Rock, TX (US)

(72) Inventor: Vaideeswaran Ganesan, Bangalore (IN)

(73) Assignee: Dell Products, L.P., Round Rock, TX (US)

(21) Appl. No.: 17/409,833

(22) Filed: Aug. 24, 2021

(30) Foreign Application Priority Data
Jul. 23, 2021 (IN) 202111033238

(51) Int. Cl. G06Q 30/00; G06F 16/81; G06F 16/955; G06F 9/445

(52) U.S. Cl. CPC G06Q 30/012; G06F 16/81; G06F 16/955; G06F 9/44526; G06Q 30/018

(57) ABSTRACT

Systems and methods are disclosed for consolidating warranty information for IHS components from multiple vendors. A service module or agent component running on an operating system works with a baseboard management controller to retrieve warranty information. A Universal Warranty Data Definition (UWDD) model is used to represent warranty information for components from various vendors. A Warranty Exchange Protocol (WEP) is used to exchange warranty information with vendors using the UWDD model. Vendors establish a website that implements the Warranty Exchange Protocol. When a vendor's components are installed in an IHS, a UWDD plugin for the service module provides information associated with the vendor's UWDD website, such as a website URI and access credentials. The baseboard management controller uses the UWDD plugin information to collect warranty information for the components and to present the warranty information to a data center administrator.

### CROSS REFERENCE TO RELATED APPLICATIONS

This patent application claims priority to co-pending, commonly assigned Indian Patent Application No. 202111033238, filed Jul. 23, 2021 and entitled “Universal Warranty Exchange Protocol for Unsupported Technologies,” the entire contents of which are incorporated by reference herein.

### FIELD

The present disclosure generally relates to Information Handling Systems (IHSs) in data centers and, more particularly, to obtaining warranty data for add-on components from third-party vendors to support management of the data center IHSs.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Groups of IHSs may be housed within data center environments. A data center may include a large number of IHSs, such as enterprise blade servers that are stacked and installed within racks. A data center may include large numbers of such server racks that are organized into rows of racks. Administration of such large groups of IHSs may require teams of remote and local administrators working in shifts in order to support around-the-clock availability of the data center operations while minimizing any downtime. A data center may include a wide variety of hardware systems and software applications that may each be separately licensed and supported. Individual hardware and software systems at use within a data center may be subject to different warranty conditions when those systems are supported by different manufacturers and are subject to different installation dates.

### SUMMARY

In various embodiments, systems and methods are provided for consolidating warranty information for IHS components from multiple vendors. A service module or agent component running on an operating system works with a baseboard management controller to retrieve warranty information. A Universal Warranty Data Definition (UWDD) model is used to represent warranty information for components from various vendors. A Warranty Exchange Protocol (WEP) is used to exchange warranty information with vendors using the UWDD model. Vendors establish a website that implements the Warranty Exchange Protocol. When a vendor's components are installed in an IHS, a UWDD plugin for the service module provides information associated with the vendor's UWDD website, such as a website URI and access credentials. The baseboard management controller uses the UWDD plugin information to collect warranty information for the components and to present the warranty information to a data center administrator.

The warranty information consolidation methods disclosed herein prevent a user, such as a data center administrator, from having to view warranty sites from different vendors to determine Service Level Agreement (SLA) limitations for a particular IHS. The universal warranty model enables warranties to be represented in a standardized model thereby enabling exchange across multiple vendors. Additionally, this allows for homogeneous interpretation of the warranty aspects, which enables customers to have a common interpretation across multiple vendors. Furthermore, the methods provide for a server-level integrated warranty experience by collecting warranty information from various vendor websites and presenting a single dashboard of warranty information for all IHS components.

### BRIEF DESCRIPTION OF THE DRAWINGS

The present invention(s) is/are illustrated by way of example and is/are not limited by the accompanying figures. Elements in the figures are illustrated for simplicity and clarity and have not necessarily been drawn to scale.

FIG. 1 is a block diagram illustrating certain components of a chassis supporting a plurality of IHSs and configured according to various embodiments for support of a universal warranty exchange protocol.

FIG. 2 is a block diagram illustrating certain components of an IHS that may be a component of a chassis and is configured according to various embodiments for support of a universal warranty exchange protocol.

FIG. 3 illustrates an IHS for implementing a universal warranty exchange protocol for supporting hardware and/or software from multiple vendors.

FIG. 4 illustrates an example user interface, such as a user dashboard, for displaying warranty data for IHS components.

FIG. 5 is a flowchart illustrating a process for managing an Information Handling System comprising components from multiple vendors.

### DETAILED DESCRIPTION

A data center may include a large number of IHSs that may be installed as components of a chassis. A rack structure may house several different chassis, and a data center may include numerous racks. Components of the IHSs may be provided by multiple vendors and may be installed at different times. Accordingly, data center administrators face significant difficulties in assessing the current warranty coverage of the components within the data center. A data center may include a large number of licensed hardware and software systems. Upon expiration of warranty coverage, such data center hardware and software systems are no longer supported by their manufacturer, seller, re-seller, or other entity that has been contracted to provide support. In some scenarios, a hardware and software system this is out of warranty may impact the ability of the data center to provide a contracted service level agreements (SLA) with customers. Embodiments provide capabilities for consolidating warranty information that can be displayed seamlessly to data center administrators.

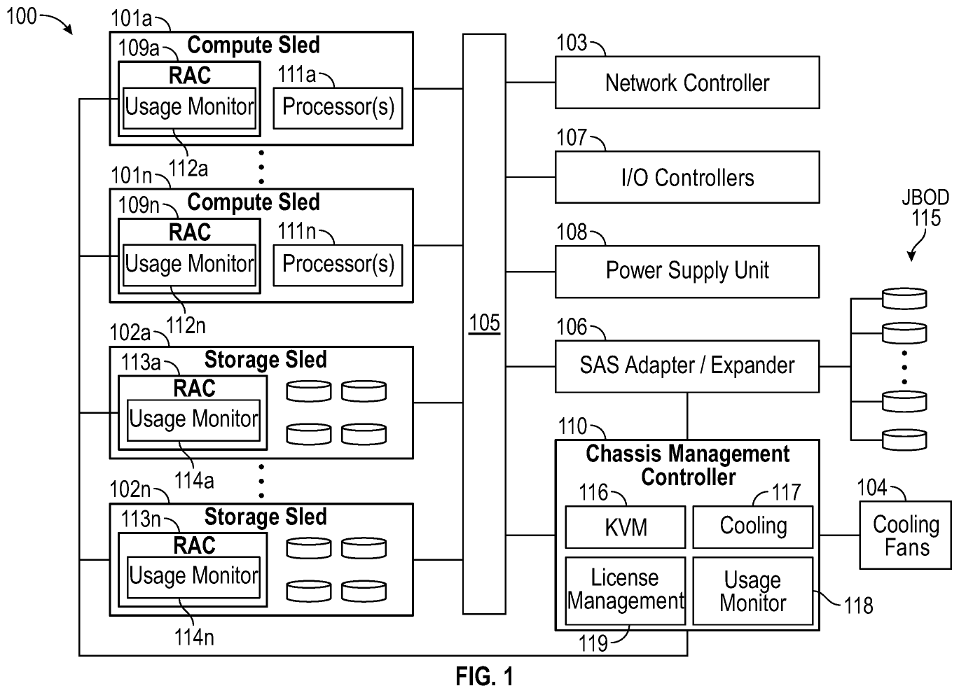

FIG. 1 is a block diagram illustrating certain components of a chassis 100 comprising one or more compute sleds 101a-n and one or more storage sleds 102a-n that may be configured to implement the systems and methods described herein. As described in additional detail below, each of the sleds 101a-n, 102a-n may be separately licensed hardware components and each of the sleds may also operate using a variety of licensed hardware and software features. Chassis 100 may include one or more bays that each receive an individual sled (that may be additionally or alternatively referred to as a tray, blade, and/or node), such as compute sleds 101a-n and storage sleds 102a-n. Chassis 100 may support a variety of different numbers (e.g., 4, 8, 16, 32), sizes (e.g., single-width, double-width), and physical configurations of bays. Other embodiments may include additional types of sleds that provide various types of storage and/or processing capabilities. Other types of sleds may provide power management and networking functions. Sleds may be individually installed and removed from the chassis 100, thus allowing the computing and storage capabilities of a chassis to be reconfigured by swapping the sleds with different types of sleds, in many cases without affecting the operations of the other sleds installed in the chassis 100.

By configuring a chassis 100 with different sleds, the chassis may be adapted to support specific types of operations, thus providing a computing solution that is directed toward a specific type of computational task. For instance, a chassis 100 that is configured to support artificial intelligence computing solutions may include additional compute sleds, compute sleds that include additional processors, and/or compute sleds that include specialized artificial intelligence processors or other specialized artificial intelligence components, such as specialized FPGAs. In another example, a chassis 100 configured to support specific data mining operations may include network controllers 103 that support high-speed couplings with other similarly configured chassis, thus supporting high-throughput, parallel-processing computing solutions.

In another example, a chassis 100 configured to support certain database operations may be configured with specific types of storage sleds 102a-n that provide increased storage space or that utilize adaptations that support optimized performance for specific types of databases. In other scenarios, a chassis 100 may be configured to support specific enterprise applications, such as by utilizing compute sleds 101a-n and storage sleds 102a-n that include additional memory resources that support simultaneous use of enterprise applications by multiple remote users. In another example, a chassis 100 may include compute sleds 101a-n and storage sleds 102a-n that support secure and isolated execution spaces for specific types of virtualized environments. In some instances, specific combinations of sleds may comprise a computing solution, such as an artificial intelligence system, that may be licensed and supported as a computing solution.

Multiple chassis 100 may be housed within a rack. Data centers may utilize large numbers of racks, with various different types of chassis installed in the various rack configurations. The modular architecture provided by the sleds, chassis, and rack allow for certain resources, such as cooling, power, and network bandwidth, to be shared by the compute sleds 101a-n and the storage sleds 102a-n, thus providing efficiency improvements, and supporting greater computational loads.

Chassis 100 may be installed within a rack structure that provides all or part of the cooling utilized by chassis 100. For airflow cooling, a rack may include one or more banks of cooling fans that may be operated to ventilate heated air away from a chassis 100 that is housed within a rack. Chassis 100 may alternatively or additionally include one or more cooling fans 104 that may be similarly operated to ventilate heated air from within the sleds 101a-n, 102a-n installed within the chassis. A rack and a chassis 100 installed within the rack may utilize various configurations and combinations of cooling fans 104 to cool the sleds 101a-n, 102a-n and other components housed within chassis 100.

Sleds 101a-n, 102a-n may be individually coupled to chassis 100 via connectors. The connectors may correspond to bays provided in the chassis 100 and may physically and electrically couple an individual sled 101a-n, 102a-n to a backplane 105. Chassis backplane 105 may be a printed circuit board that includes electrical traces and connectors that are configured to route signals between the various components of chassis 100. In various embodiments, backplane 105 may include various additional components, such as cables, wires, midplanes, backplanes, connectors, expansion slots, and multiplexers. In certain embodiments, backplane 105 may be a motherboard that includes various electronic components installed thereon. In some embodiments, components installed on a motherboard-type backplane 105 may include components that implement all or part of the functions described with regard to components such as network controller 103, SAS (Serial Attached SCSI) adapter/expander 106, I/O controllers 107, and power supply unit 108.

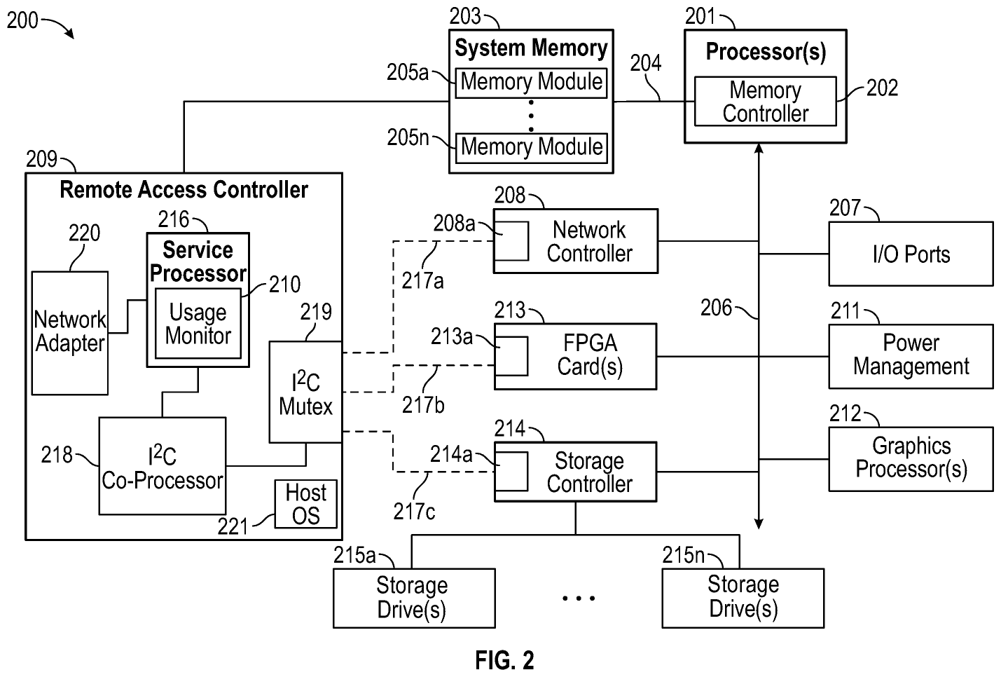

In certain embodiments, a compute sled 101a-n may be an IHS, such as described with regard to IHS 200 of FIG. 2. A compute sled 101a-n may provide computational processing resources that may be used to support a variety of e-commerce, multimedia, business, and scientific computing applications. In some cases, these applications may be provided as services via a cloud implementation. Compute sleds 101a-n are typically configured with hardware and software that provide leading-edge computational capabilities. Accordingly, services provided using such computing capabilities are typically provided as high-availability systems that operate with minimum downtime. Compute sleds 101a-n may be configured for general-purpose computing or may be optimized for specific computing tasks in support of specific computing solutions. A compute sled 101a-n may be a licensed component of a data center and may also operate using various licensed hardware and software systems.

As illustrated, each compute sled 101a-n includes a remote access controller (RAC) 109a-n. As described in additional detail with regard to FIG. 2, a remote access controller 109a-n provides capabilities for remote monitoring and management of each compute sled 101a-n. In support of these monitoring and management functions, remote access controllers 109a-n may utilize both in-band and sideband (i.e., out-of-band) communications with various internal components of a compute sled 101a-n and with other components of chassis 100. Remote access controller 109a-n may collect sensor data, such as temperature sensor readings, from components of the chassis 100 in support of airflow cooling of the chassis 100 and the sleds 101a-n, 102a-n. Also as described in additional detail with regard to FIG. 2, remote access controllers 109a-n may support communications with chassis management controller 110 where these communications may report usage data that is based on monitored use of licensed hardware and software systems by a particular sled 101a-n, 102a-n.

A compute sled 101a-n may include one or more processors 111a-n that support specialized computing operations, such as high-speed computing, artificial intelligence processing, database operations, parallel processing, graphics operations, streaming multimedia, and/or isolated execution spaces for virtualized environments. Using such specialized processor capabilities of a compute sled 101a-n, a chassis 100 may be adapted for a particular computing solution.

As indicated in FIG. 1, a compute sled 101a-n may also include a usage monitor 112a-n. An individual usage monitor 112a-n may monitor the use of licensed hardware and/or software systems of a compute sled 105a and may additionally monitor use of certain features of these licensed systems. The usage data collected by the usage monitors 112a-n may be reported to the chassis management controller 110 for forwarding. For example, the usage data may be forwarded to an external system for use in evaluating the warranty for a particular hardware and/or software system and in exchanging data using a universal warranty exchange protocol.

In some embodiments, each compute sled 101a-n may include a storage controller that may be utilized to access storage drives that are accessible via chassis 100. Some of the individual storage controllers may provide support for RAID (Redundant Array of Independent Disks) configurations of logical and physical storage drives, such as storage drives provided by storage sleds 102a-n. In some embodiments, some or all of the individual storage controllers utilized by compute sleds 101a-n may be HBAs (Host Bus Adapters) that provide more limited capabilities in accessing physical storage drives provided via storage sleds 102a-n and/or via SAS expander 106.

As illustrated, chassis 100 also includes one or more storage sleds 102a-n that are coupled to the backplane 105 and installed within one or more bays of chassis 100 in a similar manner to compute sleds 101a-n. Each of the individual storage sleds 102a-n may include various different numbers and types of storage devices. For instance, storage sleds 102a-n may include SAS (Serial Attached SCSI) magnetic disk drives, SATA (Serial Advanced Technology Attachment) magnetic disk drives, solid-state drives (SSDs), and other types of storage drives in various combinations. The storage sleds 102a-n may be utilized in various storage configurations by the compute sleds 101a-n that are coupled to chassis 100. As illustrated, each storage sled 102a-n may include a remote access controller (RAC) 113a-n. Remote access controllers 113a-n may provide capabilities for remote monitoring and management of storage sleds 102a-n in a similar manner to the remote access controllers 109a-n in compute sleds 101a-n. As described with regard to compute sleds 101a-n, the remote access controller 113a-n of each storage sled 102a-n may include a usage monitor 114a-n used to monitor the use of licensed hardware and/or software systems of a storage sled 101a-n and may additionally monitor use of certain features of these licensed systems. The usage data collected by the usage monitors 114a-n may be reported to the chassis management controller 110 for forwarding, where the usage data may be forwarded to an external system for use in evaluating the warranty for a particular hardware and/or software system and in exchanging data using a universal warranty exchange protocol.

In addition to the data storage capabilities provided by storage sleds 102a-n, chassis 100 may provide access to other storage resources 115 that may be installed as components of chassis 100 and/or may be installed elsewhere within a rack housing the chassis 100, such as within a storage blade. In certain scenarios, storage resources 115 may be accessed via SAS expander 106 that is coupled to backplane 105 of chassis 100. For example, SAS expander 106 may support connections to a number of JBOD (Just a Bunch Of Disks) storage drives 115 that may be configured and managed individually and without implementing data redundancy across the various drives 115. The additional storage resources 115 may also be at various other locations within the data center in which chassis 100 is installed. Such additional storage resources 115 may also be remotely located from chassis 100.

As illustrated, the chassis 100 of FIG. 1 includes a network controller 103 that provides network access to the sleds 101a-n, 102a-n installed within the chassis. Network controller 103 may include various switches, adapters, controllers, and couplings used to connect chassis 100 to a network, either directly or via additional networking components and connections provided via a rack in which chassis 100 is installed. In some embodiments, network controllers 103 may be replaceable components that include capabilities that support certain computing solutions, such as network controllers 103 that interface directly with network controllers from other chassis in support of clustered processing capabilities that utilize resources from multiple chassis.

Chassis 100 may also include a power supply unit 108 that provides the components of the chassis with various levels of DC power from an AC power source or from power delivered via a power system provided by the rack within which chassis 100 is installed. In certain embodiments, power supply unit 108 may be implemented within a sled that may provide chassis 100 with redundant, hot-swappable power supply units. In such embodiments, power supply unit 108 is a replaceable component that may be used in support of certain computing solutions.

Chassis 100 may also include various I/O controllers 107 that may support various I/O ports, such as USB ports that may be used to support keyboard and mouse inputs and/or video display capabilities. I/O controllers 107 may be utilized by a chassis management controller 110 to support various KVM (Keyboard, Video and Mouse) 116 capabilities that provide administrators with the ability to interface with the chassis 100.

In addition to providing support for KVM 116 capabilities for administering chassis 100, chassis management controller 110 may support various additional functions for sharing the infrastructure resources of chassis 100. In some scenarios, chassis management controller 110 may implement tools for managing the network bandwidth 103, power 108, and airflow cooling 104 that are available via the chassis 100. As described, the airflow cooling 104 utilized by chassis 100 may include an airflow cooling system that is provided by a rack in which the chassis 100 may be installed and managed by a cooling module 117 of the chassis management controller 110.

As described, components of chassis 100, such as compute sleds 101a-n and storage sleds 102a-n, may include usage monitoring 112a-n, 114a-n capabilities that may collect information regarding the usage of licensed systems and features of those licensed systems. Chassis management controller 110 may similarly include a usage monitor 118 that tracks usage information for some chassis systems that may be licensed. For instance, in some instances, aspects of power supply unit 108 and network controller 103 may utilize licensed software and hardware systems. The usage monitor 118 of the chassis management controller 110 may query such components in collecting usage data regarding licensed features of these components. In some embodiments, chassis 100 may operate a license management service, such as license management capability 119, that tracks the licensed hardware and software systems operating on a particular chassis.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail below.

FIG. 2 illustrates an example IHS 200 configured to implement the systems and methods described herein. It should be appreciated that although the embodiments described herein may describe an IHS that is a compute sled or similar computing component that may be deployed within the bays of a chassis, other embodiments may be utilized with other types of IHSs. In the illustrative embodiment of FIG. 2, IHS 200 may be a computing component, such as compute sled 101a-n, that is configured to share infrastructure resources provided by a chassis 100 in support of specific computing solutions.

IHS 200 may be a compute sled that is installed within a large system of similarly configured IHSs that may be housed within the same chassis, rack and/or data center. IHS 200 may utilize one or more processors 201. In some embodiments, processors 201 may include a main processor and a co-processor, each of which may include a plurality of processing cores that, in certain scenarios, may each be used to run an instance of a server process. In certain embodiments, one, some or all processor 201 may be graphics processing units (GPUs). In some embodiments, one, some, or all processors 201 may be specialized processors, such as artificial intelligence processors or processor adapted to support high-throughput parallel processing computations. As described, such specialized adaptations of IHS 200 may be used to implement specific computing solutions support by the chassis in which IHS 200 is installed.

As illustrated, processor 201 includes an integrated memory controller 202 that may be implemented directly within the circuitry of the processor 201, or memory controller 202 may be a separate integrated circuit that is located on the same die as the processor 201. Memory controller 202 may be configured to manage the transfer of data to and from a system memory 203 of the IHS 201 via a high-speed memory interface 204.

System memory 203 is coupled to processor 201 via a memory bus 204 that provides the processor 201 with high-speed memory used in the execution of computer program instructions by the processor 201. Accordingly, system memory 203 may include memory components, such as such as static RAM (SRAM), dynamic RAM (DRAM), or NAND Flash memory, suitable for supporting high-speed memory operations by the processor 201. In certain embodiments, system memory 203 may combine both persistent, non-volatile memory, and volatile memory.

In certain embodiments, system memory 203 may be comprised of multiple removable memory modules. System memory 203 in the illustrated embodiment includes removable memory modules 205a-n. Each of the removable memory modules 205a-n may correspond to a printed circuit board memory socket that receives a removable memory module 205a-n, such as a DIMM (Dual In-line Memory Module), that can be coupled to the socket and then decoupled from the socket as needed, such as to upgrade memory capabilities or to replace faulty components. Other embodiments of IHS system memory 203 may be configured with memory socket interfaces that correspond to different types of removable memory module form factors, such as a Dual In-line Package (DIP) memory, a Single In-line Pin Package (SIPP) memory, a Single In-line Memory Module (SIMM), and/or a Ball Grid Array (BGA) memory.

IHS 200 may utilize a chipset that may be implemented by integrated circuits that are connected to each processor 201. All or portions of the chipset may be implemented directly within the integrated circuitry of an individual processor 201. The chipset may provide the processor 201 with access to a variety of resources accessible via one or more buses 206. Various embodiments may utilize any number of buses to provide the illustrated pathways served by bus 206. In certain embodiments, bus 206 may include a PCIe (PCI Express) switch fabric that is accessed via a PCIe root complex. IHS 200 may also include one or more I/O ports 207, such as PCIe ports, that may be used to couple the IHS 200 directly to other IHSs, storage resources or other peripheral components. In certain embodiments, the I/O ports 207 may provide couplings to the backplane of the chassis in which the IHS 200 is installed.

As illustrated, a variety of resources may be coupled to the processor 201 of the IHS 200 via bus 206. For instance, processor 201 may be coupled to a network controller 208, such as provided by a Network Interface Controller (NIC) that is coupled to the IHS 200 and allows the IHS 200 to communicate via an external network, such as the Internet or a LAN. As illustrated, network controller 208 may report usage information to a remote access controller 209 via an out-of-band signaling pathway that is independent of the operating system of the IHS 200. In some embodiments, network controller 208 may collect and report certain usage information to usage monitor 210 of a remote access controller 209. For example, network controller 208 may collect and report usage data regarding use of the network controller 208, such as the number of a specific type of network operation performed by the network controller 208.

Processor 201 may also be coupled to a power management unit 211 that may interface with power system unit 108 of chassis 100 in which an IHS 200, such as a compute sled 101a-n, may be installed. In certain embodiments, a graphics processor 212 may be comprised within one or more video or graphics cards, or an embedded controller, installed as components of IHS 200. In certain embodiments, graphics processor 212 may be an integrated of the remote access controller 209 and may be utilized to support the display of diagnostic and administrative interfaces related to IHS 200 via display devices that are coupled, either directly or remotely, to remote access controller 209.

As illustrated, IHS 200 may include one or more FPGA (Field-Programmable Gate Array) card(s) 213. Each of the FPGA cards 213 supported by IHS 200 may include various processing and memory resources, in addition to an FPGA integrated circuit that may be reconfigured after deployment of IHS 200 through programming functions supported by FPGA card 213. Each individual FGPA card 213 may be optimized to perform specific processing tasks, such as specific signal processing, security, data mining, and artificial intelligence functions, and/or to support specific hardware coupled to IHS 200. In certain embodiments, such specialized functions supported by an FPGA card 213 may be utilized by IHS 200 in support of certain computing solutions. In some embodiments, FPGA 213 may collect and report certain usage information to the usage monitor 210 of the remote access controller 209. For example, an FPGA 213 may collect and report usage data regarding overall use of the FPGA 213, such as the number of operations performed by the FPGA 213 or such as an amount of processing time by FPGA 213. In certain embodiments, FPGA 213 may also track usage data for certain features of the FPGA, such as the number of times a specific capability for which an FPGA has been programmed is actually used. For example, FPGA 213 may collect information regarding use of a specific image processing or artificial intelligence function that is implemented by the FPGA. As illustrated, FPGA 213 may report such usage information to the remote access controller 209 via an out-of-band signaling pathway that is independent of the operating system of the IHS 200.

IHS 200 may also support one or more storage controllers 214 that may be utilized to provide access to virtual storage configurations. For instance, storage controller 214 may provide support for RAID (Redundant Array of Independent Disks) configurations of storage devices 215a-n, such as storage drives provided by storage sleds 102a-n and/or JBOD 115 of FIG. 1. In some embodiments, storage controller 214 may be an HBA (Host Bus Adapter). In some embodiments, storage controller 214 may also collect and report certain usage information to the usage monitor 210 of the remote access controller 209. For example, a storage controller 214 may collect and report usage data regarding overall use of the storage controller 214, such as the number of storage operations performed by the storage controller 214. In certain embodiments, storage controller 214 may also track usage data for specific features of the storage controller's operation. Illustrative examples of such features include the number of times a specific RAID operation has been performed, the number of storage operations involving a particular storage sled or other storage drives 215a-n, the number of storage operations, and the number of operations involving a particular computing solution, such as specific operations in support of a data mining solution. Storage controller 214 may report such usage information to the remote access controller 209 via an out-of-band signaling pathway that is independent of the operating system of the IHS 200.

In certain embodiments, IHS 200 may operate using a BIOS (Basic Input/Output System) that may be stored in a non-volatile memory accessible by the processor(s) 201. The BIOS may provide an abstraction layer by which the operating system of the IHS 200 interfaces with the hardware components of the IHS. Upon powering or restarting IHS 200, processor 201 may utilize BIOS instructions to initialize and test hardware components coupled to the IHS, including both components permanently installed as components of the motherboard of IHS 200, and removable components installed within various expansion slots supported by the IHS 200. The BIOS instructions may also load an operating system for use by the IHS 200. In some embodiments, BIOS instructions may be used to collect and report certain usage information to the usage monitor 210 of the remote access controller 209. For example, BIOS may collect and report usage data regarding the use of particular hardware components. In certain embodiments, IHS 200 may utilize Unified Extensible Firmware Interface (UEFI) in addition to or instead of a BIOS. In certain embodiments, the functions provided by a BIOS may be implemented, in full or in part, by the remote access controller 209.

In certain embodiments, remote access controller 209 may operate from a different power plane from the processors 201 and other components of IHS 200, thus allowing the remote access controller 209 to operate, and management tasks to proceed, while the processing cores of IHS 200 are powered off. As described, various functions provided by the BIOS, including launching the operating system of the IHS 200, may be implemented by the remote access controller 209. In some embodiments, the remote access controller 209 may perform various functions to verify the integrity of the IHS 200 and its hardware components prior to initialization of the IHS 200 (i.e., in a bare-metal state).

Remote access controller 209 may include a service processor 216, or specialized microcontroller, that operates management software that supports remote monitoring and administration of IHS 200. Remote access controller 209 may be installed on the motherboard of IHS 200 or may be coupled to IHS 200 via an expansion slot provided by the motherboard. In support of remote monitoring functions, network adapter 208c may support connections with remote access controller 209 using wired and/or wireless network connections via a variety of network technologies.

In some embodiments, remote access controller 209 may support monitoring and administration of various devices 208, 213, 214 of an IHS via a sideband interface. In such embodiments, the messages in support of the monitoring and management function may be implemented using MCTP (Management Component Transport Protocol) that may be transmitted using I2C sideband bus connections 217a-c established with each of the respective managed devices 208, 213, 214. As illustrated, the managed hardware components of the IHS 200, such as FPGA cards 213, network controller 208 and storage controller 214, are coupled to the IHS processor 201 via an in-line bus 206, such as a PCIe root complex, that is separate from the I2C sideband bus connection 217a-c.

In certain embodiments, the service processor 216 of remote access controller 209 may rely on an I2C co-processor 218 to implement sideband I2C communications between the remote access controller 209 and managed components 208, 213, 214 of the IHS. The I2C co-processor 218 may be a specialized co-processor or micro-controller that is configured to interface via a sideband I2C bus interface with the managed hardware components 208, 213, 214 of IHS. In some embodiments, the I2C co-processor 218 may be an integrated component of the service processor 216, such as a peripheral system-on-chip feature that may be provided by the service processor 216. Each I2C bus 217a-c is illustrated as single line in FIG. 2. However, each I2C bus 217a-c may be comprised of a clock line and data line that couple the remote access controller 209 to I2C endpoints 208a, 213a, 214a.

As illustrated, the I2C co-processor 218 may interface with the individual managed devices 208 , 213, and 214 via individual sideband I2C buses 217a-c selected through the operation of an I2C multiplexer 219. Via switching operations by the I2C multiplexer 219, a sideband bus connection 217a-c may be established by a direct coupling between the I2C co-processor 218 and an individual managed device 208, 213, or 214.

In providing sideband management capabilities, the I2C co-processor 218 may each interoperate with corresponding endpoint I2C controllers 208a, 213a, 214a that implement the I2C communications of the respective managed devices 208, 213, 214. The endpoint I2C controllers 208a, 213a, 214a may be implemented as a dedicated microcontroller for communicating sideband I2C messages with the remote access controller 209, or endpoint I2C controllers 208a, 213a, 214a may be integrated SoC functions of a processor of the respective managed device endpoints 208, 213, 214.

As described, a compute node such as IHS 200 may include a usage monitor 210 that collects and monitors usage information for hardware and software systems of IHS 200. In some embodiments, a usage monitor 210 may be implemented as a process of remote access controller 209, where the usage data from components 208, 213, 214 may be collected by service processor 216 via the out-of-band management connections 217a-c supported by I2C co-processor 218. The collected usage data may then be reported to the chassis management controller via a connection supported by the network adapter 220 of the remote access controller 209.

In some embodiments, the usage monitor 210 of remote access controller 209 may periodically query managed components 208, 213, 214 in order to collect usage data from these components. In some embodiments, usage monitor 210 may provide managed components 208, 213, 214 with instructions regarding the data to be collected. In some embodiments, usage monitor 210 may store collected usage data until prompted to provide this data by a chassis management controller or by an administrative process.

In various embodiments, an IHS 200 does not include each of the components shown in FIG. 2. In various embodiments, an IHS 200 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor 201 as a systems-on-a-chip.

In some embodiments, the remote access controller 209 may include or may be part of a baseboard management controller (BMC). As a non-limiting example of a remote access controller 209, the integrated Dell Remote Access Controller (iDRAC) from Dell® is embedded within Dell PowerEdge™ servers and provides functionality that helps information technology (IT) administrators deploy, update, monitor, and maintain servers remotely. In other embodiments, chassis management controller 110 may include or may be an integral part of a baseboard management controller. Remote access controller 209 may be used to monitor, and in some cases manage computer hardware components of IHS 200. Remote access controller 209 may be programmed using a firmware stack that configures remote access controller 209 for performing out-of-band (e.g., external to a computer's operating system or BIOS) hardware management tasks. Remote access controller 209 may run a host operating system (OS) 221 on which various agents execute. The agents may include, for example, a service module 250 that is suitable to interface with remote access controller 209 including, but not limited to, an iDRAC service module (iSM).

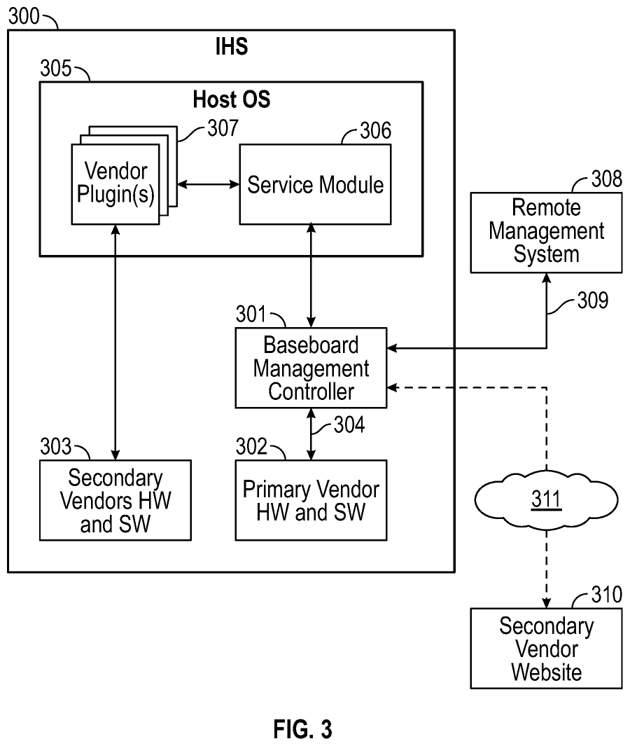

FIG. 3 illustrates an IHS 300 for implementing a universal warranty exchange protocol for supporting hardware and/or software from multiple vendors. A baseboard management controller (BMC) 301 provides administrative management for IHS 300. BMC 301 may generally include a specialized microcontroller embedded on the motherboard of IHS 300 and provides an interface between system-management software and platform hardware. Different types of sensors built into the IHS report to the BMC 301 on parameters such as temperature, cooling fan speeds, power status, operating system (O/S) status, and the like. The BMC 301 monitors the sensors and can send alerts to a system administrator via the network if any of the parameters do not stay within pre-set limits, indicating a potential failure of the system. The administrator can also remotely communicate with the BMC 301 to take some corrective actions, such as resetting or power cycling the system to get a hung O/S running again.

BMC 301 is used to remotely manage the hardware and software of IHS 300. As illustrated, the hardware and software that are managed BMC 301 include various hardware and software 302 provided by a primary vendor and hardware and software 303 provided by one or more secondary vendors. This hardware and software 302, 303 may include various types of network controllers, storage controllers, processors, memory resources, storage devices and various other hardware and software components that may be managed remotely using a standardized remote management interface, such as the Redfish interface. The primary vendor hardware and software components 302 may be accessed via a sideband management connection 304 by BMC 301 and may also be accessed via an in-band management connection by operating system 305 of the IHS 300.

BMC 301 may collect telemetry data from primary vendor hardware and software components 302 both via the sideband management connection 304 and from service module 306 that operates within the operating system 305. In one embodiment, service module 306 may be an iDRAC Service Module (iSM) that is configured to operate with BMC 301, which may be an integrated Dell remote access controller (iDRAC), which are both provided by DELL INC. In other embodiments, service module 306 may be any other monitoring agent or agent extension. The primary vendor hardware and software components 302 may be sourced from various original manufacturers, such as different processor, memory, and software sources. The hardware and software components 302 are then sold as a package by the primary vendor, which also supports the hardware and software components 302 under a primary vendor warranty.

IHS 300 may also include secondary vendor hardware and software components 303. Users of an IHS may choose to install hardware and software components in order to address particular computing needs. For instance, a user may install a card that has been programmed to provide specialized network management tasks that also include support for specialized cryptographic capabilities. In such a scenario, the secondary vendor hardware and software components are supported under separate warranty agreements that are managed by the secondary vendors. In order to support management of secondary vendor hardware and software 303, the host operating system 305 may include modules, such as device plugins 307, that interface with the secondary vendor hardware and software components 303 directly. Whereas BMC 301 may utilize standard procedures for supporting the primary vendor hardware and software components 302, each device plugin 307 that supports a secondary vendor hardware or software component 303 must be customized to support the particular needs and capabilities of these components 303. Device plugins 307 may be installed, for example, as part of a driver package for secondary vendor hardware and software components 303.

The warranties on the hardware and software components 302, 303 from the primary and secondary vendors allow a data center administrator to ensure that the data center performs within the contracted SLA with its customers. Warranties typically provide various levels of support comprising different response times. The availability of certain warranties may depend, for example, upon data center location relative to the vendor's support personnel or other supply chain issues. If a hardware or software component 302, 303 breaks down or is not functioning, then the associated warranty must provide service, such as repair or replacement, within the SLA requirements that the data center has with its customers. For example, critical workloads should generally be assigned to IHSs 300 having warranties with the fastest repair/replacement times to ensure that the IHSs 300 are available for the assigned workloads.

The primary vendor hardware and software components 302 may conform to an existing management interface, such as Redfish, and BMC 301 may provide telemetry data to a remote monitoring system 308 via remote management messaging 309 that conforms to a remote management interface. The telemetry data collected by the BMC 301 may then be made available in various forms to administrators via remote management system 308. A data center administrator may use remote management system 308 to get warranty information for hardware and software components 302 since those components were provided by the primary vendor and, therefore, warranty information is known during IHS 300 configuration and setup.

However, the secondary vendor hardware and software 303 is not covered under the primary vendor's warranty support. As a result, the data center administrator must look to each individual secondary vendor to determine the warranty coverage for hardware and software 303. This secondary vendor warranty information may be available through vendor websites, for example, which requires the data center administrator to search for warranty information for each secondary vendor component separately. In current data center environments, the administrator must independently track this secondary vendor warranty information in order to ensure that each IHS 300 has an appropriate group of warranty coverage to meet the SLA for the assigned workloads.

In embodiment disclosed herein, warranty information for all primary and secondary vendor hardware and software components 302, 303 is consolidated by BMC 301 and is available to data center administrators via remote management system 308. This solution allows service module 306 to identify the secondary vendor hardware and software components 303 to BMC 301, which then accesses second vendor websites 310 via a public or private network 311, such as the Internet, to collect the relevant warranty information for each component 303.

In order to exchange and use warranty information across multiple vendors, a Universal Warranty Data Definition (UWDD) model is defined. The UWDD model may be an XML definition schema that contains the definitions of warranty parts. An example UWDD model schema may define an XML document having the following elements:
a) Name: a string that gives a short name of the warranty;
b) Vendor: a string that gives an unambiguous name of the vendor or manufacturer of the secondary hardware or software component;
c) Warranty Type: an enumeration of component types (Software/Hardware);
d) Warranty Replacement SLA: an enumeration of the level of services expected by customer from vendor (e.g., next business day (NBD), second business day (SBD), four hours (4 H), eight hours (8 H), mission critical (MC), etc.);
e) Support Type: an enumeration of types of support provided (e.g., level one, two, or three (L1, L1+L2, L1+L2+L3), Post Support, or other support based on standard naming conventions;
f) Product Name; a string name of the product (e.g., the commercial or brand name of the hardware or software component);
g) Product Type; an optional string representing type of product (e.g., empty, Basic, Advanced, Enterprise, Enterprise Plus, etc.);
h) Feature Name: an optional string representing one or more feature names, if multiple features are separately supported by the product;
i) Full Warranty Name: a complete name of the warranty component;
j) Start Warranty Date: a date when the warranty for the component starts;
k) End Warranty Date: a date when the warranty for the component ends;
l) Additional List of Fields: an array of strings that are returned by the warranty provider.

Any vendor that supports this integrated warranty representation would provide a public user interface 310 that can return the above information in a standard format, such as JSON, XML, SOAP, etc.

An example of the UWDD data in JSON format is:
{“partid”: “ID12322323”, “name”: “Acme ABC card”, “vendor”: “Acme”, “warranty-type”: “hardware”, “warranty-sla”: “mc”, “full-warranty-name”: “Acme Mission Critical Warranty” “start-warranty-date”: “20210304T00:00:00”, “end-warranty-date”: “20220304T00:00:00”, “fields”: {“acme-ext-vendor”: “dell”, “acme-ext-geo”: “apj”}

A Warranty Exchange Protocol (WEP) may be used to exchange UWDD information for components with an unsupported (e.g., secondary) vendor. The WEP may be, for example, a simple request/response RESTful interface, such as a Redfish interface. In one embodiment, BMC 301 initiates the WEP to a secondary vendor's implementation of a UWDD provider, such as website 310. The WEP uses the standard Application Programming Interfaces (APIs) for the interface, such as Redfish. In addition, the WEP includes the following set of APIs:
1) /uwdd/v1/info
This API returns information about the vendor website. The secondary vendor site may return a simple JSON format, such as:

{“owner”: “acme.inc”, “version”: “1.0”}; and
2) /uwdd/v1/warranty/{partid}
This API requests information about the component. The secondary vendor site may return a JSON format that contains the UWDD, such as:

{“partid”: “ID12322323”, “name”: “Acme ABC card”, “vendor”: “Acme”, “warranty-type”: “hardware”, “warranty-sla”: “mc”, “full-warranty-name”: “Acme Mission Critical Warranty” “start-warranty-date”: “20200304T00:00:00”, “end-warranty-date”: “20220304T00:00:00”, “fields”: {“acme-ext-vendor”: “dell”, “acme-ext-geo”: “apj”}.

Secondary vendor website 310 is a public website that is used to provide warranty information in the UWDD format. Website 310 implements the URIs that are requested by BMC 301 in the WEP.

Vendor plugin(s) 307 include one or more UWDD vendor plugins that are integrated with service module 306. The UWDD vendor plugins 307 provide the service module 306 with: (1) a UWDD secondary vendor website (i.e., a URI for website 310), and (2) UWDD secondary vendor website credentials. This information is provided to service module 306, which then pushes the information to BMC 301. Service module 306 may use a specialized Intelligent Platform Management Interface (IPMI) command to communicate with BMC 301.

BMC 301 requires an Internet or other connection 312 to communicate with website 310 via network 311. Using connection 312, BMC 301 polls for any of the UWDD interfaces registered through service module 306. BMC 301 then collects warranty information from website 301. BMC 301 may then display warranty information to a data center administrator.

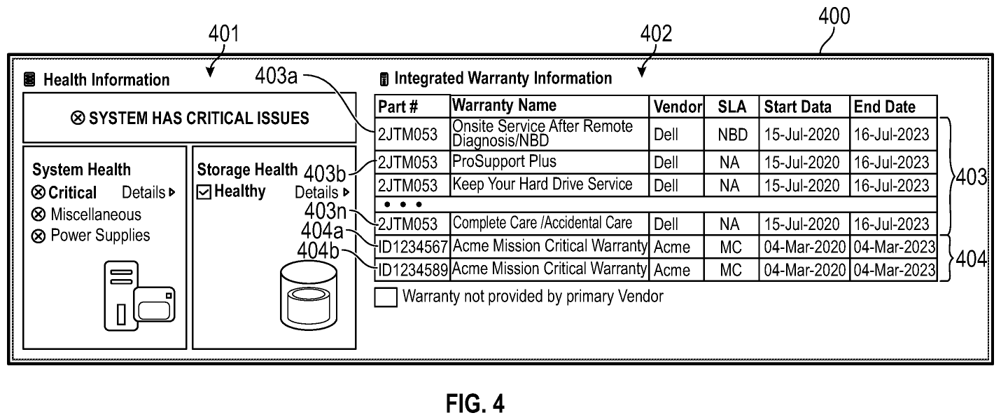

FIG. 4 illustrates an example user interface 400, such as a dashboard on a system management console, for displaying IHS data to a data center administrator or other IT personnel. Section 401 provides IHS health information, such as indications of healthy or critical indications for IHS components. Section 402 is a representation of warranty information collected by BMC 301 for the IHS components. The warranty information may be displayed as a table that identifies important warranty parameters for each component. Hardware and software components 302 that are provided by the primary vendor are grouped in rows 403.

In the illustrated embodiment shown in FIG. 4, interface 400 lists primary vendor components 403a-n in rows 403, such as components included as part of an original IHS deployment. Components 403a-n may be manufactured by the primary vendor and/or may be sourced from a third-party original equipment manufacturer (OEM) and then included in the IHS configured by the primary vendor. As result, components 403a-n are supported by a warranty from the primary vendor. The data center administrator may later add additional components 404a-b, such as network cards (e.g., PCIe cards), specialized FPGA cards, etc., that are provided by secondary vendors (i.e., not part of an original deployment or an upgrade by the primary vendor). Since the additional components 404a-b are provided by a secondary vendor, they are not covered by the primary vendor's warranty terms. The embodiments disclosed herein allow a BMC, chassis controller, remote access controller, or other component of an IHS or cluster to collect warranty information for secondary vendor components 404a-b. Additionally, the embodiments disclosed herein provide a standardized warranty information reporting format, which allows a data center administrator or IT personnel to understand relevant warranty terms for all components.

The information displayed on example interface 400 indicates that component 403a is subject to a warranty that provides next business day (NBD) service and repair conditions. On the other hand, warranties for components 403b-n do not specify an SLA level. The secondary vendor components 404a-b shown in rows 402 both have a mission critical (MC) SLA. Using this information, a data center administrator can determine what types of customer workloads should be assigned (or not be assigned) to the associated IHS based upon the available SLA.

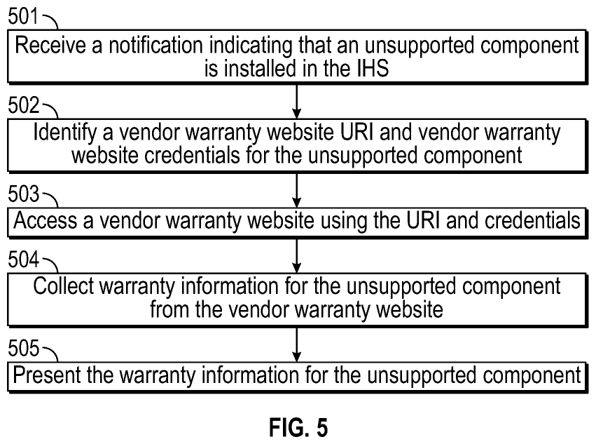

FIG. 5 is a flowchart illustrating a process for managing an Information Handling System comprising components from multiple vendors. In step 501, a notification is received indicating that an unsupported component is installed in the Information Handling System (IHS). The unsupported component is not covered by a primary warranty. The notification indicating that an unsupported component is installed may be provided by a vendor plugin to an IHS operating system. The vendor plugin may be a component of a driver for the unsupported component.

In step 502, a vendor warranty website URI and vendor warranty website credentials are identified for the unsupported component. The URI and credentials may be identified, for example, by an IHS service module executing on a host operating system.

In step 503, a vendor warranty website is accessed using the URI and credentials. The vendor warranty website may be accessed, for example, by an IHS controller, such as a baseboard management controller, a remote access controller, or a chassis management controller. The vendor warranty website URI and vendor warranty website credentials may be identified using a vendor plugin to an IHS operating system. The vendor warranty website may be accessed using a warranty exchange protocol. The warranty exchange protocol may comprise a set of APIs that support exchange of the universal warranty data definition model.

In step 504, warranty information for the unsupported component is collected from the vendor warranty website. The warranty information may be formatted using a universal warranty data definition model, which may be defined by an XML schema. The universal warranty data definition model identifies an SLA for the unsupported component, which allows the user to determine an SLA that the IHS can support.

In step 505, the warranty information for the unsupported component is presented to a user. The warranty information for the unsupported component may be presented to the user via a remote management or monitoring system that also presents warranty information for components that are covered by the primary warranty.

In an example embodiment, a method for managing an IHS having components from multiple vendors comprises receiving a notification from an operating system service module indicating that an unsupported component is installed in the IHS, wherein the unsupported component is not covered by a primary warranty; and identifying, by the service module, a vendor warranty website URI and vendor warranty website credentials for the unsupported component. The method further comprises accessing, by an IHS controller, a vendor warranty website using the URI and credentials; collecting warranty information for the unsupported component from the vendor warranty website; and presenting the warranty information for the unsupported component to a user. The vendor warranty website URI and vendor warranty website credentials may be identified using a vendor plugin to an IHS operating system.

The collected warranty information may be formatted using a universal warranty data definition model. The universal warranty data definition model may be defined by an XML schema. The vendor warranty website may be accessed by the IHS controller using a warranty exchange protocol. The warranty exchange protocol may comprise a set of APIs that support exchange of the universal warranty data definition model. The universal warranty data definition model may identify a service level agreement for the unsupported component.

The notification indicating that an unsupported component is installed may be provided by a vendor plugin to an IHS operating system. The vendor plugin may be a component of a driver for the unsupported component.

The warranty information for the unsupported component may be presented to the user via a remote management system that also presents warranty information for components that are covered by the primary warranty.

In another example embodiment, a remote access controller is configured as a component of an IHS. The remote access controller comprises one or more processors, and a memory device coupled to the one or more processors. The memory device stores computer-readable instructions that, upon execution by the one or more processors, cause the remote access controller to receive a notification from an operating system service module that an unsupported component is installed in the IHS, wherein the unsupported component is not covered by a primary warranty, identify a vendor warranty website URI and vendor warranty website credentials associated with the unsupported component, access a vendor warranty website using the URI and credentials, collect warranty information for the unsupported component from the vendor warranty website, and present the warranty information for the unsupported component to a user.

The collected warranty information collected by the remote access controller may be formatted using a universal warranty data definition model. The universal warranty data definition model may be defined by an XML schema. The vendor warranty website may be accessed by the remote access controller using a warranty exchange protocol. The warranty exchange protocol comprises a set of APIs that support exchange of the universal warranty data definition model. The universal warranty data definition model may identify, for example, a service level agreement for the unsupported component.

The remote access controller may further comprise a vendor plugin to an IHS operating system. The vendor plugin may provide the notification indicating that an unsupported component is installed. The vendor plugin may be, for example, a component of a driver for the unsupported component. The vendor plugin may identify the vendor warranty website URI and vendor warranty website credentials.

The remote access controller may further comprise a remote management interface to a remote monitoring system. The warranty information for the unsupported component may be presented to the user via the remote monitoring system that also presents warranty information for components that are covered by the primary warranty.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

What is claimed is:

1. A method for managing an Information Handling System (IHS) comprising components from multiple vendors, the method comprising:
receiving a notification from an operating system service module indicating that an unsupported component is installed in the IHS, wherein the unsupported component is not covered by a primary warranty;
identifying, by the service module, a vendor warranty website URI and vendor warranty website credentials for the unsupported component;
accessing, by an IHS controller, a vendor warranty website using the URI and credentials;
collecting warranty information for the unsupported component from the vendor warranty website; and
presenting the warranty information for the unsupported component to a user.

2. The method of claim 1, wherein the collected warranty information is formatted using a universal warranty data definition model.

3. The method of claim 2, wherein the universal warranty data definition model is defined by an XML schema.

4. The method of claim 2, wherein the vendor warranty website is accessed by the IHS controller using a warranty exchange protocol.

5. The method of claim 4, wherein the warranty exchange protocol comprises a set of APIs that support exchange of the universal warranty data definition model.

6. The method of claim 1, wherein the notification indicating that an unsupported component is installed is provided by a vendor plugin to an IHS operating system.

7. The method of claim 6, wherein the vendor plugin is a component of a driver for the unsupported component.

8. The method of claim 1, wherein the vendor warranty website URI and vendor warranty website credentials are identified using a vendor plugin to an IHS operating system.

9. The method of claim 1, wherein the warranty information for the unsupported component is presented to the user via a remote management system that also presents warranty information for components that are covered by the primary warranty.

10. The method of claim 1, wherein the universal warranty data definition model identifies a service level agreement for the unsupported component.

11. A remote access controller configured as a component of an Information Handling System (IHS), the remote access controller comprising:
one or more processors; and
a memory device coupled to the one or more processors, the memory device storing computer-readable instructions that, upon execution by the one or more processors, cause the remote access controller to:
receive a notification from an operating system service module that an unsupported component is installed in the IHS, wherein the unsupported component is not covered by a primary warranty;
identify a vendor warranty website URI and vendor warranty website credentials associated with the unsupported component;
access a vendor warranty website using the URI and credentials;
collect warranty information for the unsupported component from the vendor warranty website; and
present the warranty information for the unsupported component to a user.

12. The remote access controller of claim 11, wherein the collected warranty information is formatted using a universal warranty data definition model.

13. The remote access controller of claim 12, wherein the universal warranty data definition model is defined by an XML schema.

14. The remote access controller of claim 11, wherein the vendor warranty website is accessed by the controller using a warranty exchange protocol.

15. The remote access controller of claim 12, wherein the warranty exchange protocol comprises a set of APIs that support exchange of the universal warranty data definition model.

16. The remote access controller of claim 11, further comprising:
a vendor plugin to an IHS operating system, wherein the vendor plugin provides the notification indicating that an unsupported component is installed.

17. The remote access controller of 16, wherein the vendor plugin is a component of a driver for the unsupported component.

18. The remote access controller of 11, further comprising:
a vendor plugin to an IHS operating system, wherein the vendor plugin identifies the vendor warranty website URI and vendor warranty website credentials.

19. The remote access controller of 11, further comprising:
a remote management interface to a remote monitoring system, wherein the warranty information for the unsupported component is presented to the user via the remote monitoring system that also presents warranty information for components that are covered by the primary warranty.

20. The remote access controller of 12, wherein the universal warranty data definition model identifies a service level agreement for the unsupported component.
